(19) United States
(12) Patent Application Publication
(10) Pub. No.: US 2013/0151030 A1
(43) Pub. Date: Jun. 13, 2013

(54) DRIVING CONDITION DETERMINATION APPARATUS

(71) Applicant: Denso Corporation, Kariya-city (JP)

(72) Inventor: Takuya TATSUMI, Obu-city (JP)

(73) Assignee: DENSO CORPORATION, Kariya-city (JP)

(21) Appl. No.: 13/672,850

(22) Filed: Nov. 9, 2012

(30) Foreign Application Priority Data
Dec. 9, 2011 (JP) 2011-269936
Sep. 14, 2012 (JP) 2012-202796

(51) Int. Cl. G06F 17/00; B62D 15/02

(52) U.S. Cl. 701/1

(57) ABSTRACT

A driving condition determination apparatus includes: an image obtaining device for obtaining a driver face image; a direction detector for detecting a face direction and/or a visual line direction of the driver; a steering wheel angle detector for determining whether a steering wheel angle exceeds a threshold value; and a determination device for determining whether the face direction and/or the visual line direction, which has been detected within a time interval just before the steering wheel angle exceeds the threshold value, satisfies a first condition and/or a second condition. The first condition is that the face direction and/or the visual line direction turns to a rearview mirror of the vehicle, and the second condition is that the face direction and/or the visual line direction turns to a door mirror or a side mirror on a side, to which the steering wheel is turned.

### CROSS REFERENCE TO RELATED APPLICATIONS

This application is based on Japanese Patent Applications No. 2011-269936 filed on Dec. 9, 2011, and No. 2012-202796 filed on Sep. 14, 2012, the disclosures of which are incorporated herein by reference.

### TECHNICAL FIELD

The present disclosure relates to a driving condition determination apparatus.

### BACKGROUND

Conventionally, an in-vehicle apparatus mounted on a vehicle for preventing an accident of the vehicle is provided. For example, the apparatus detects a warning point while the vehicle runs. The apparatus guides an order of mirrors, which a driver of the vehicle should pay attention to and watch at the warning point. JP-A-2007-334829 teaches such an apparatus.

In order to prevent an accident, when the vehicle turns right or left, or when the vehicle changes a traffic lane, it is necessary for the driver to confirm a right side, a left side and/or a rear side of the vehicle before turning and changing. A driver, who looks aside while driving or drives the vehicle inattentive, may fail to confirm the right side, the left side and/or the rear side of the vehicle. In JP-A-2007-334829, the apparatus only guides the order of mirrors. Thus, the apparatus does not provide solution of the above issues.

### SUMMARY

It is an object of the present disclosure to provide a driving condition determination apparatus.

According to a first aspect of the present disclosure, a driving condition determination apparatus includes: an image obtaining device for obtaining an image including a face of a driver of a vehicle; a direction detector for analyzing the image and for detecting at least one of a face direction and a visual line direction of the driver; a steering wheel angle detector for detecting a steering wheel angle of a steering wheel of the vehicle and for determining whether the steering wheel angle exceeds a predetermined first threshold value; and a determination device for determining whether the at least one of the face direction and the visual line direction, which has been detected within a predetermined time interval just before the steering wheel angle detector determines that the steering wheel angle exceeds the predetermined first threshold value, satisfies at least one of a first condition and a second condition in a case where the steering wheel angle exceeds the predetermined first threshold value. The first condition is such that the at least one of the face direction and the visual line direction turns to a rearview mirror of the vehicle, and the second condition is such that the at least one of the face direction and the visual line direction turns to a door mirror or a side mirror disposed on a side, to which the steering wheel is turned.

In the above apparatus, when the driver does not confirm a right side, a left side and/or a rear side of the vehicle before the vehicle turns right or left, or before the vehicle changes a traffic lane, the apparatus detects such a behavior of the driver. Thus, the apparatus reduces a possibility of the traffic accident.

Alternatively, the driving condition determination apparatus may further include: a vehicle speed detector for detecting a vehicle speed of the vehicle; and a threshold setting device for setting the first threshold value based on the vehicle speed.

Further, the driving condition determination apparatus may further include: a turn signal detector for detecting a turn signal. The determination device determines whether the at least one of the face direction and the visual line direction satisfies the at least one of the first condition and the second condition when the turn signal detector detects the turn signal. Furthermore, the determination device may not determine whether the at least one of the face direction and the visual line direction satisfies the at least one of the first condition and the second condition when the turn signal detector does not detect the turn signal. In these cases, the apparatus prevents from unnecessary determination if the vehicle does not turns right or left, and the vehicle does not change the traffic lane.

Alternatively, the driving condition determination apparatus may further include: a warning device for outputting warning information when the determination device determines that both of the first condition and the second condition are not satisfied. The apparatus controls the warning device to output the warning information when the driver does not confirm a right side, a left side and/or a rear side of the vehicle. The warning information is provided by voice message, display message, vibration message or the like.

According to a second aspect of the present disclosure, a driving condition determination apparatus includes: an image obtaining device for obtaining an image including a face of a driver of a vehicle; a direction detector for analyzing the image and for detecting at least one of a face direction and a visual line direction of the driver; a duration time detector for detecting an steering wheel angle of a steering wheel of the vehicle and for determining whether a duration time, for which the steering wheel angle is continuously equal to or larger than a predetermined standard value, exceeds a predetermined second threshold value; and a determination device for determining whether the at least one of the face direction and the visual line direction, which has been detected within a predetermined time interval just before the duration time detector determines that the duration time exceeds the predetermined second threshold value, satisfies at least one of a first condition and a second condition in a case where the duration time exceeds the predetermined second threshold value. The first condition is such that the at least one of the face direction and the visual line direction turns to a rearview mirror of the vehicle, and the second condition is such that the at least one of the face direction and the visual line direction turns to a door mirror or a side mirror disposed on a side, to which the steering wheel is turned.

In the above apparatus, when the driver does not confirm a right side, a left side and/or a rear side of the vehicle before the vehicle turns right or left, or before the vehicle changes a traffic lane, the apparatus detects such a behavior of the driver. Thus, the apparatus reduces a possibility of the traffic accident.

According to a third aspect of the present disclosure, a driving condition determination apparatus includes: an image obtaining device for obtaining an image including a face of a driver of a vehicle; a direction detector for analyzing the image and for detecting at least one of a face direction and a visual line direction of the driver; a steering wheel angle detector for detecting an steering wheel angle of a steering wheel of the vehicle and for determining whether the steering wheel angle exceeds a predetermined first threshold value; a duration time detector for determining whether a duration time, for which the steering wheel angle is continuously equal to or larger than a predetermined standard value, exceeds a predetermined second threshold value; and a determination device for determining whether the at least one of the face direction and the visual line direction, which has been detected within a predetermined time interval just before the steering wheel angle detector determines that the steering wheel angle exceeds the predetermined first threshold value or the duration time detector determines that the duration time exceeds the predetermined second threshold value, satisfies at least one of a first condition and a second condition in a case where the steering wheel angle exceeds the predetermined first threshold value, or the duration time exceeds the predetermined second threshold value. The first condition is such that the at least one of the face direction and the visual line direction turns to a rearview mirror of the vehicle, and the second condition is such that the at least one of the face direction and the visual line direction turns to a door mirror or a side mirror disposed on a side, to which the steering wheel is turned.

In the above apparatus, when the driver does not confirm a right side, a left side and/or a rear side of the vehicle before the vehicle turns right or left, or before the vehicle changes a traffic lane, the apparatus detects such a behavior of the driver. Thus, the apparatus reduces a possibility of the traffic accident.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a driving condition determination apparatus;

FIG. 2 is a flowchart showing a process for detecting a face direction and a visual line direction;

FIG. 3 is a flowchart showing a driving condition determination process;

FIG. 4 is a flowchart showing another driving condition determination process;

FIG. 5 is a block diagram showing another driving condition determination apparatus;

FIG. 6 is a flowchart showing further another driving condition determination process;

FIGS. 7A and 7B are graphs showing a relationship between a vehicle speed and a threshold;

FIG. 8 is a flowchart showing another driving condition determination process; and

FIG. 9 is a flowchart showing another driving condition determination process.

### DETAILED DESCRIPTION

Example embodiments of the present disclosure will be explained with reference to drawings as follows.

### First Embodiment

1. Structure of Driving Condition Determination Apparatus

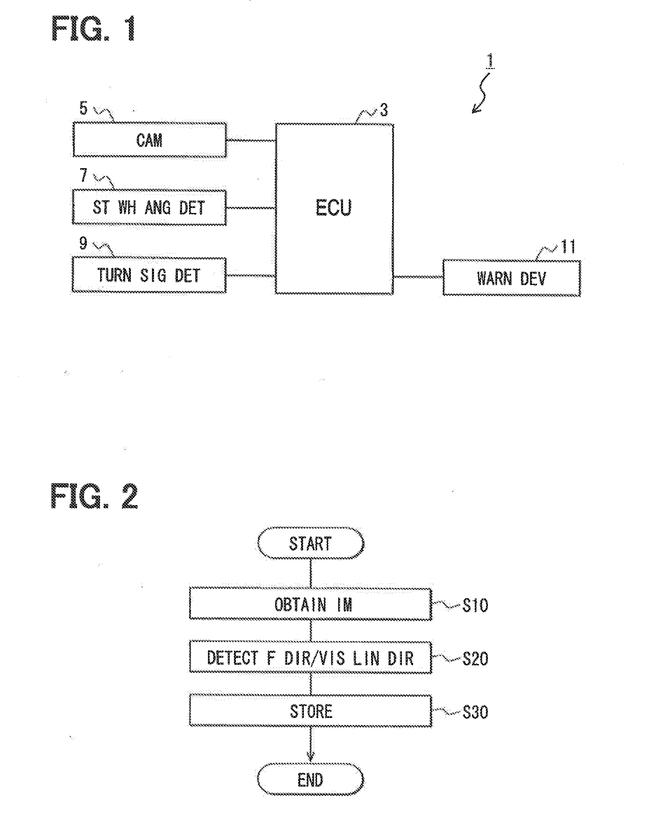

A driving condition determination apparatus 1 will be explained with reference to FIG. 1. FIG. 1 is a block diagram showing the apparatus 1.

The apparatus 1 is an in-vehicle apparatus mounted on a vehicle. The apparatus 1 includes a ECU (i.e., electric control unit) 3, a camera 5, a steering wheel angle detector 7, a turn signal detector 9 and a warning device 11. The ECU 3 provides a detector for detecting a face and/or a visual line direction, and a determination device. The camera 5 provides an image obtaining device. The steering wheel angle detector 7 provides a steering wheel detecting mechanism. The turn signal detector 9 provides a turn signal detecting mechanism. The warning device 11 provides a warning element. The devices are connected to each other via a CAN (controller area network).

The ECU 3 includes a conventional computer for executing the later described process. The camera 5 is a digital camera attached to the steering wheel. The camera 5 shoots an image including the face of the driver.

The steering wheel angle detector 7 includes another ECU (not shown) mounted on the vehicle. The detector 7 detects a steering wheel angle of the vehicle. Further, the detector 7 inputs a detection signal to the ECU 3. Here, the steering wheel angle is defined as zero when the steering wheel is disposed at a neutral position so that the driver does not turn the steering wheel. When the driver turns the steering wheel to a right side by X degrees, the steering wheel angle is defined as +X degrees. When the driver turns the steering wheel to a left side by X degrees, the steering wheel angle is defined as −X degrees.

The turn signal detector 9 includes another ECU (not shown) mounted on the vehicle. The detector 9 detects a turn-on state of the turn signal. Further, the detector 9 outputs a detection signal toward the ECU 3. The turn signal includes a right turn signal and a left turn signal.

The warning device 11 includes a speaker (not shown). The warning device 11 outputs a voice message such as “attention, please” or a warning sound via the speaker.

2. Process Executed by Driving Condition Determination Apparatus

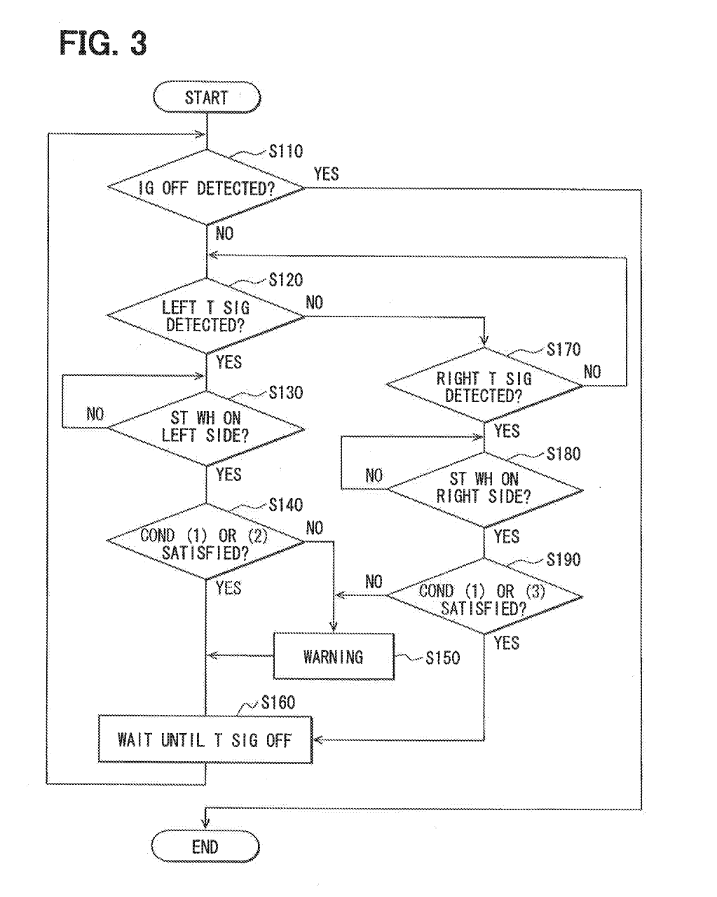

A process executed by the driving condition determination apparatus 1 will be explained with reference to FIGS. 2 and 3.

(1) Process for Detecting a Face Direction and a Visual Line Direction

The apparatus 1 repeats the process for detecting a face direction and a visual line direction in FIG. 2 at predetermined time intervals.

In step S10 of FIG. 2, the camera 5 obtains an image including a face of the driver.

In step S20, the apparatus 1 analyzes the image obtained in step S10 so that the apparatus 1 detects the face direction and the visual line direction of the driver. A method for detecting the face direction and the visual line direction with the image analysis is a conventional method, disclosed in, for example, JP-A-2002-352228, JP-A-2007-249280, and JP-A-2005-182452.

In step S30, a memory in the ECU 3 stores information about the face direction and the visual line direction of the driver, which are detected in step S20. Here, every time the apparatus 1 repeats step S20, the memory stores the information about the face direction and the visual line direction of the driver cumulatively. Further, the memory stores the information in relation to time, at which the apparatus 1 detects the information.

(2) Driving Condition Determination Process

The apparatus 1 repeats a driving condition determination apparatus in FIG. 3 at predetermined time intervals independently from the process for detecting the face direction and the visual line direction.

In step S110, the apparatus 1 detects whether an ignition switch of the vehicle is in an off state. When the ignition switch is not in the off state, it goes to step S120. When the ignition switch is in the off state, the process ends.

In step S120, the apparatus 1 determines whether the turn signal detector 9 detects the left turn signal. When the detector 9 detects the left turn signal, it goes to step S130. When the detector 9 does not detect the left turn signal, it goes to step S170.

In step S130, the apparatus 1 determines whether the steering wheel angle is equal to or larger than 20 degrees (i.e., a threshold value A) on the left side. When the determination in step S130 is “YES,” it goes to step S140. When the determination in step S130 is “NO,” it returns to step S130.

In step S140, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than 20 degrees on the left side. Further, the apparatus 1 determines whether at least one of the following conditions (1) and (2) is satisfied in the read-out information about the face direction and the visual line direction.

(1) The face direction and/or the visual line direction turn to the rearview mirror.

(2) The face direction and/or the visual line direction turn to the left side mirror or a door mirror.

Here, the apparatus 1 preliminary stores the information about the direction toward the rearview mirror and the direction toward the left side mirror or the door mirror. The direction toward the rearview mirror and the direction toward the left side mirror or the door mirror include a predetermined range of a direction having a certain width. For example, the direction toward the rearview mirror has a center of the range, which is disposed along a line directed to the center of the rearview mirror. The range of the direction toward the rearview mirror is disposed within a predetermined solid angle around the center. The direction toward the left side mirror or the door mirror also has the predetermined range defined by a predetermined solid angle around a center.

When both of the above conditions (1) and (2) are not satisfied, it goes to step S150. When at least one of the above conditions (1) and (2) is satisfied, it goes to step S160.

In step S150, the apparatus 1 controls the speaker of the warning device 11 to output a warning sound or a voice message “attention, please.”

In step S160, the apparatus waits until the turn signal is off. After that, it goes to step S110.

When the determination in step S120 is “NO,” it goes to step S170. In step S170, the apparatus 1 determines whether the turn signal detector 9 detects the right turn signal. When the turn signal detector 9 detects the right turn signal, it goes to step S180. When the turn signal detector 9 does not detect the right turn signal, it goes to step S120.

In step S180, the apparatus 1 determines whether the steering wheel angle is equal to or larger than 20 degrees (i.e., a threshold value A) on the right side. When the determination in step S180 is “YES,” it goes to step S190. When the determination in step S180 is “NO,” it returns to step S180.

In step S190, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than 20 degrees on the right side. Further, the apparatus 1 determines whether at least one of the following conditions (1) and (3) is satisfied in the read-out information about the face direction and the visual line direction. Here, the apparatus 1 preliminary stores the information about the direction toward the rearview mirror and the direction toward the right side mirror or the door mirror.

(1) The face direction and/or the visual line direction turn to the rearview mirror.

(3) The face direction and/or the visual line direction turn to the right side mirror or a door mirror.

Here, the apparatus 1 preliminary stores the information about the direction toward the rearview mirror and the direction toward the right side mirror or the door mirror. The direction toward the rearview mirror and the direction toward the right side mirror or the door mirror include a predetermined range of a direction having a certain width. For example, the direction toward the rearview mirror has a center of the range, which is disposed along a line directed to the center of the rearview mirror. The range of the direction toward the rearview mirror is disposed within a predetermined solid angle around the center. The direction toward the right side mirror or the door mirror also has the predetermined range defined by a predetermined solid angle around a center.

When both of the above conditions (1) and (3) are not satisfied, it goes to step S150. When at least one of the above conditions (1) and (3) is satisfied, it goes to step S160.

3. Effects of Apparatus

In the apparatus 1, when the driver does not check both ways and/or the rear side (i.e., when the conditions (1) and (2) or the conditions (1) and (3) are not satisfied) before the vehicle changes a traffic lane or the vehicle turns right or left (i.e., before the steering wheel angle is equal to or larger than 20 degrees), the apparatus 1 detects the behavior of the driver who does not check, and further, the apparatus outputs the warning sound and/or the warning message. Thus, the apparatus 1 reduces a possibility of traffic accidents.

Further, when the apparatus 1 does not detect the turn signal, i.e., when it is considered that the vehicle does not change the traffic lane and turn right or left, the apparatus 1 does not detect the behavior of the driver and output the warning sound and the warning message. Accordingly, unnecessary detection and the warning process is not performed.

### Second Embodiment

1. Structure of Driving Condition Determination Apparatus

The structure of the driving condition determination apparatus is similar to the first embodiment.

2. Process Executed by Driving Condition Determination Apparatus

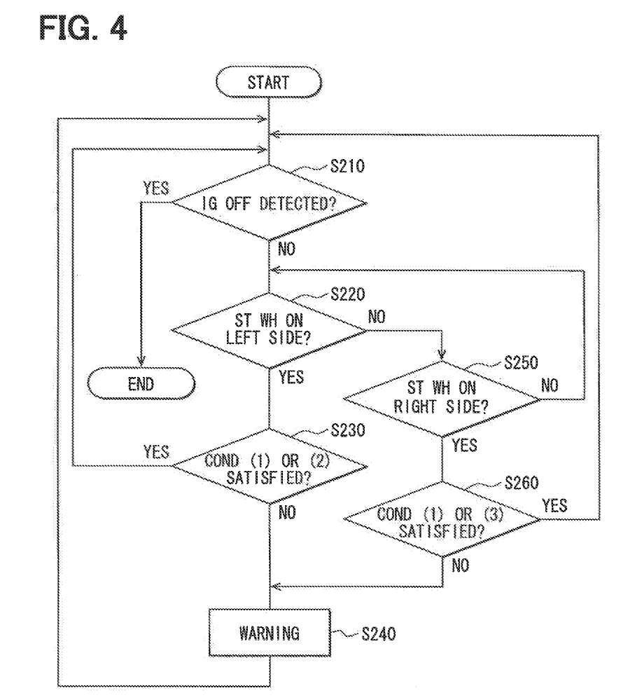

A process executed by the driving condition determination apparatus 1 will be explained with reference to FIGS. 2 and 4.

(1) Process for Detecting a Face Direction and a Visual Line Direction

The apparatus 1 repeats the process for detecting a face direction and a visual line direction in FIG. 2 at predetermined time intervals, similar to the first embodiment.

(2) Driving Condition Determination Process

The apparatus 1 repeats a driving condition determination apparatus in FIG. 4 at predetermined time intervals independently from the process for detecting the face direction and the visual line direction.

In step S210, the apparatus 1 detects whether an ignition switch of the vehicle is in an off state. When the ignition switch is not in the off state, it goes to step S220. When the ignition switch is in the off state, the process ends.

In step S220, the apparatus 1 determines whether the steering wheel angle is equal to or larger than 20 degrees (i.e., a threshold value A) on the left side. When the determination in step S220 is “YES,” it goes to step S230. When the determination in step S220 is “NO,” it goes to step S250.

In step S230, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than 20 degrees on the left side. Further, the apparatus 1 determines whether at least one of the following conditions (1) and (2) is satisfied in the read-out information about the face direction and the visual line direction.

(1) The face direction and/or the visual line direction turn to the rearview mirror.

(2) The face direction and/or the visual line direction turn to the left side mirror or a door mirror.

Here, the apparatus 1 preliminary stores the information about the direction toward the rearview mirror and the direction toward the left side mirror or the door mirror. The direction toward the rearview mirror and the direction toward the left side mirror or the door mirror include a predetermined range of a direction having a certain width.

When both of the above conditions (1) and (2) are not satisfied, it goes to step S240. When at least one of the above conditions (1) and (2) is satisfied, it goes to step S210.

In step S240, the apparatus 1 controls the speaker of the warning device 11 to output a warning sound or a voice message “attention, please.”

When the determination in step S220 is “NO,” it goes to step S250. In step S250, the apparatus 1 determines whether the steering wheel angle is equal to or larger than 20 degrees (i.e., a threshold value A) on the right side. When the determination in step S250 is “YES,” it goes to step S260. When the determination in step S250 is “NO,” it returns to step S220.

In step S260, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than 20 degrees on the right side. Further, the apparatus 1 determines whether at least one of the following conditions (1) and (3) is satisfied in the read-out information about the face direction and the visual line direction.

(1) The face direction and/or the visual line direction turn to the rearview mirror.

(3) The face direction and/or the visual line direction turn to the right side mirror or a door mirror.

Here, the apparatus 1 preliminary stores the information about the direction toward the rearview mirror and the direction toward the right side mirror or the door mirror. The direction toward the rearview mirror and the direction toward the right side mirror or the door mirror include a predetermined range of a direction having a certain width.

When both of the above conditions (1) and (3) are not satisfied, it goes to step S240. When at least one of the above conditions (1) and (3) is satisfied, it goes to step S210.

3. Effects of Apparatus

In the apparatus 1, when the driver does not check both ways and/or the rear side before the vehicle changes a traffic lane or the vehicle turns right or left, the apparatus 1 detects the behavior of the driver who does not check, and further, the apparatus outputs the warning sound and/or the warning message. Thus, the apparatus 1 reduces a possibility of traffic accidents.

### Third Embodiment

1. Structure of Driving Condition Determination Apparatus

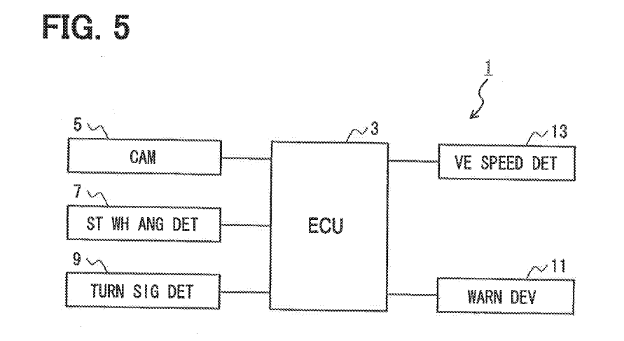

As shown in FIG. 5, a driving condition determination apparatus 1 according to the present embodiment further includes a vehicle speed detector (vehicle speed detecting device) 13 for detecting a vehicle speed of the vehicle, on which the driving condition determination apparatus 1 is mounted, in addition to the structure of the apparatus 1 according to the first embodiment. The ECU 3 functions as a threshold setting device.

2. Process Executed by Driving Condition Determination Apparatus

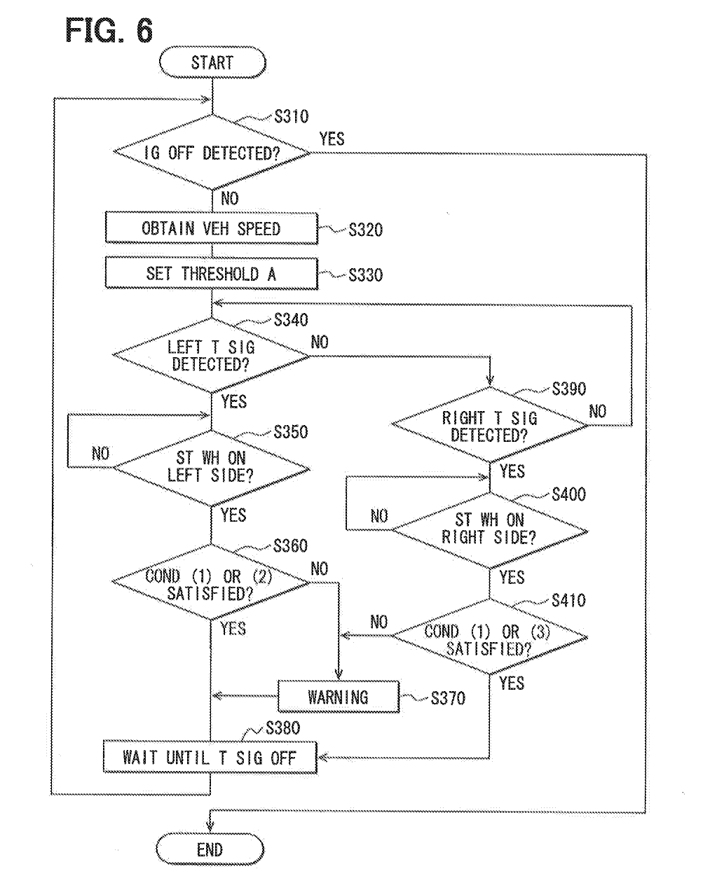

A process executed by the driving condition determination apparatus 1 (i.e., the ECU 3) will be explained with reference to FIGS. 2 and 6.

(1) Process for Detecting a Face Direction and a Visual Line Direction

The apparatus 1 repeats the process for detecting a face direction and a visual line direction in FIG. 2 at predetermined time intervals, similar to the first embodiment.

(2) Driving Condition Determination Process

The apparatus 1 repeats a driving condition determination apparatus in FIG. 6 at predetermined time intervals independently from the process for detecting the face direction and the visual line direction.

In step S310, the apparatus 1 detects whether an ignition switch of the vehicle is in an off state. When the ignition switch is not in the off state, it goes to step S320. When the ignition switch is in the off state, the process ends.

In step S320, the vehicle speed detector 13 detects the vehicle speed of the vehicle, on which the apparatus 1 is mounted.

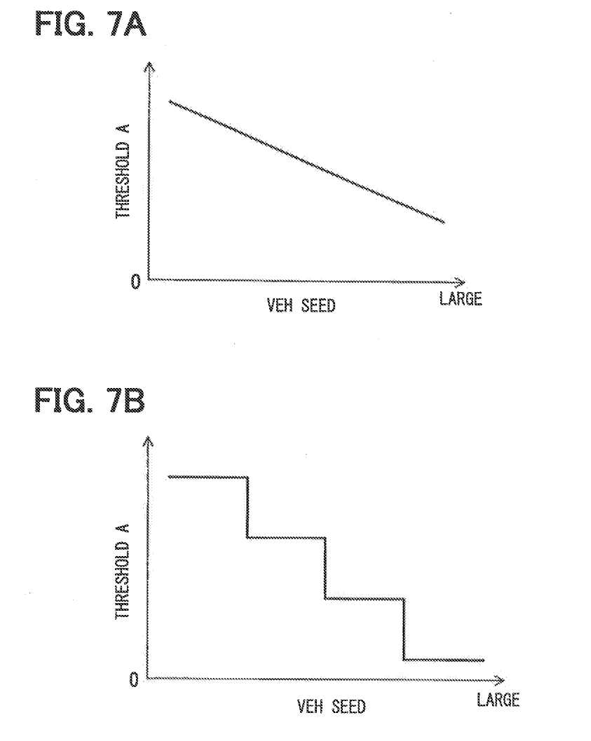

In step S330, the apparatus 1 sets the threshold value A according to the vehicle speed of the vehicle detected in step S320. Specifically, the apparatus 1 sets the threshold value A by comparing the current speed of the vehicle detected in step S320 and a map defining a relationship between the vehicle speed and the threshold value A. The map is preliminary stored in the ECU 3. In the map, when the vehicle speed is large, the threshold value A is small. For example, as shown in FIG. 7A, as the speed becomes larger, the threshold value A becomes smaller. In this case, the threshold value A is linearly reduced with the vehicle speed. Alternatively, as shown in FIG. 7B, as the speed becomes larger, the threshold value A is reduced step-wisely. Here, the threshold value A is used in steps S350 and S400.

In step S340, the apparatus 1 determines whether the turn signal detector 9 detects the left turn signal. When the detector 9 detects the left turn signal, it goes to step S350. When the detector 9 does not detect the left turn signal, it goes to step S390.

In step S350, the apparatus 1 determines whether the steering wheel angle is equal to or larger than the threshold value A on the left side. When the determination in step S350 is “YES,” it goes to step S360. When the determination in step S350 is “NO,” it returns to step S350.

In step S360, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than the threshold value A on the left side. Further, the apparatus 1 determines whether at least one of the following conditions (1) and (2) is satisfied in the read-out information about the face direction and the visual line direction.

(1) The face direction and/or the visual line direction turn to the rearview mirror.

(2) The face direction and/or the visual line direction turn to the left side mirror or a door mirror.

The definition of the direction toward the rearview mirror and the direction toward the left side mirror or the door mirror is the same as in the first embodiment.

When both of the above conditions (1) and (2) are not satisfied, it goes to step S370. When at least one of the above conditions (1) and (2) is satisfied, it goes to step S380.

In step S370, the apparatus 1 controls the speaker of the warning device 11 to output a warning sound or a voice message “attention, please.”

In step S380, the apparatus waits until the turn signal is off. After that, it goes to step S310.

When the determination in step S340 is “NO,” it goes to step S390. In step S390, the apparatus 1 determines whether the turn signal detector 9 detects the right turn signal. When the turn signal detector 9 detects the right turn signal, it goes to step S400. When the turn signal detector 9 does not detect the right turn signal, it goes to step S340.

In step S400, the apparatus 1 determines whether the steering wheel angle is equal to or larger than the threshold value A on the right side. When the determination in step S400 is “YES,” it goes to step S410. When the determination in step S400 is “NO,” it returns to step S400.

In step S410, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than the threshold value A on the right side. Further, the apparatus 1 determines whether at least one of the following conditions (1) and (3) is satisfied in the read-out information about the face direction and the visual line direction.

(1) The face direction and/or the visual line direction turn to the rearview mirror.

(3) The face direction and/or the visual line direction turn to the right side mirror or a door mirror.

Here, the definition of the direction toward the rearview mirror and the direction toward the right side mirror or the door mirror is the same as in the first embodiment.

When both of the above conditions (1) and (3) are not satisfied, it goes to step S370. When at least one of the above conditions (1) and (3) is satisfied, it goes to step S380.

3. Effects of Apparatus

The driving condition determination apparatus 1 has the similar effects according to the first embodiment.

Further, in the apparatus 1 according to the present embodiment, the threshold value A is set according to the vehicle speed. Specifically, when the vehicle speed increases, the threshold value A is reduced. Thus, the apparatus 1 appropriately controls to output the warning sound and/or the warning message. Specifically, when the speed increases, the steering wheel angle for changing the traffic lane or turning right or left is reduced. Thus, when the threshold value A is set such that the threshold value A is reduced as the speed increases, the apparatus 1 determines in high accuracy without depending on the vehicle speed whether the vehicle changes the traffic lane or turns right or left.

### Fourth Embodiment

1. Structure of Driving Condition Determination Apparatus

The structure of a driving condition determination apparatus according to the present embodiment is similar to the third embodiment.

2. Process Executed by Driving Condition Determination Apparatus

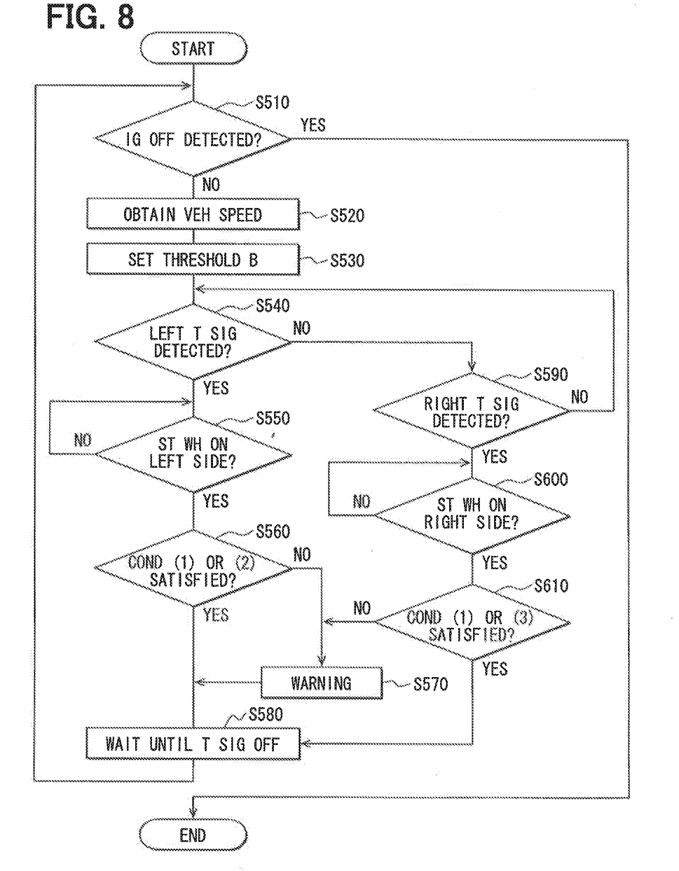

A process executed by the driving condition determination apparatus 1 (i.e., the ECU 3) will be explained with reference to FIGS. 2 and 8.

(1) Process for Detecting a Face Direction and a Visual Line Direction

The apparatus 1 repeats the process for detecting a face direction and a visual line direction in FIG. 2 at predetermined time intervals, similar to the first embodiment.

(2) Driving Condition Determination Process

The apparatus 1 repeats a driving condition determination apparatus in FIG. 8 at predetermined time intervals independently from the process for detecting the face direction and the visual line direction.

In step S510, the apparatus 1 detects whether an ignition switch of the vehicle is in an off state. When the ignition switch is not in the off state, it goes to step S520. When the ignition switch is in the off state, the process ends.

In step S520, the vehicle speed detector 13 detects the vehicle speed of the vehicle, on which the apparatus 1 is mounted.

In step S530, the apparatus 1 sets the threshold value B according to the vehicle speed of the vehicle detected in step S520. Specifically, the apparatus 1 sets the threshold value B by comparing the current speed of the vehicle detected in step S520 and a map defining a relationship between the vehicle speed and the threshold value B. The map is preliminary stored in the ECU 3. In the map, when the vehicle speed is large, the threshold value B is small. The relationship between the speed and the threshold B in the map is similar to that in the third embodiment. Here, the threshold value B is used in steps S550 and S600.

In step S540, the apparatus 1 determines whether the turn signal detector 9 detects the left turn signal. When the detector 9 detects the left turn signal, it goes to step S550. When the detector 9 does not detect the left turn signal, it goes to step S590.

In step S550, the apparatus 1 determines whether duration time of a state such that the steering wheel angle is continuously equal to or larger than 10 degrees (which is a standard value) is larger than the threshold value B. When the determination in step S550 is “YES,” i.e., when the duration time exceeds the threshold value B, it goes to step S560. When the determination in step S550 is “NO,” i.e., when the duration time does not exceed the threshold value B, the apparatus repeats step S550.

In step S560, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than 10 degrees on the left side. Further, the apparatus 1 determines whether at least one of the following conditions (1) and (2) is satisfied in the read-out information about the face direction and the visual line direction.

(1) The face direction and/or the visual line direction turn to the rearview mirror.

(2) The face direction and/or the visual line direction turn to the left side mirror or a door mirror.

The definition of the direction toward the rearview mirror and the direction toward the left side mirror or the door mirror is the same as in the first embodiment.

When both of the above conditions (1) and (2) are not satisfied, it goes to step S570. When at least one of the above conditions (1) and (2) is satisfied, it goes to step S580.

In step S570, the apparatus 1 controls the speaker of the warning device 11 to output a warning sound or a voice message “attention, please.”

In step S580, the apparatus waits until the turn signal is off. After that, it goes to step S510.

When the determination in step S540 is “NO,” it goes to step S590. In step S590, the apparatus 1 determines whether the turn signal detector 9 detects the right turn signal. When the turn signal detector 9 detects the right turn signal, it goes to step S600. When the turn signal detector 9 does not detect the right turn signal, it goes to step S540.

In step S600, the apparatus 1 determines whether the duration time of a state such that the steering wheel angle is continuously equal to or larger than 10 degrees (which is a standard value) is larger than the threshold value B. When the determination in step S600 is “YES,” i.e., when the duration time exceeds the threshold value B, it goes to step S610. When the determination in step S600 is “NO,” i.e., when the duration time does not exceed the threshold value B, the apparatus repeats step S600.

In step S610, the apparatus 1 reads out all of the information about the face direction and the visual line direction of the driver (stored in step S30), which has been stored in the memory in the ECU 3 for last three seconds just before the apparatus 1 detects that the steering wheel angle is equal to or larger than 10 degrees on the right side. Further, the apparatus 1 determines whether at least one of the following conditions (1) and (2) is satisfied in the read-out information about the face direction and the visual line direction.

(1) The face direction and/or the visual line direction turn to the rearview mirror.

(3) The face direction and/or the visual line direction turn to the right side mirror or a door mirror.

Here, the definition of the direction toward the rearview mirror and the direction toward the right side mirror or the door mirror is the same as in the first embodiment.

When both of the above conditions (1) and (3) are not satisfied, it goes to step S570. When at least one of the above conditions (1) and (3) is satisfied, it goes to step S580.

3. Effects of Apparatus

The driving condition determination apparatus 1 has the similar effects according to the first embodiment.

Further, in the apparatus 1 according to the present embodiment, the threshold value B is set according to the vehicle speed. Specifically, when the vehicle speed increases, the threshold value B is reduced. Thus, the apparatus 1 appropriately controls to output the warning sound and/or the warning message. Specifically, when the speed increases, the duration time for turning the steering wheel in order to change the traffic lane or to turn right or left is reduced. Thus, when the threshold value B is set such that the threshold value B is reduced as the speed increases, the apparatus 1 determines in high accuracy without depending on the vehicle speed whether the vehicle changes the traffic lane or turns right or left.

### Fifth Embodiment

1. Structure of Driving Condition Determination Apparatus

The structure of a driving condition determination apparatus according to the present embodiment is similar to the third embodiment.

2. Process Executed by Driving Condition Determination Apparatus

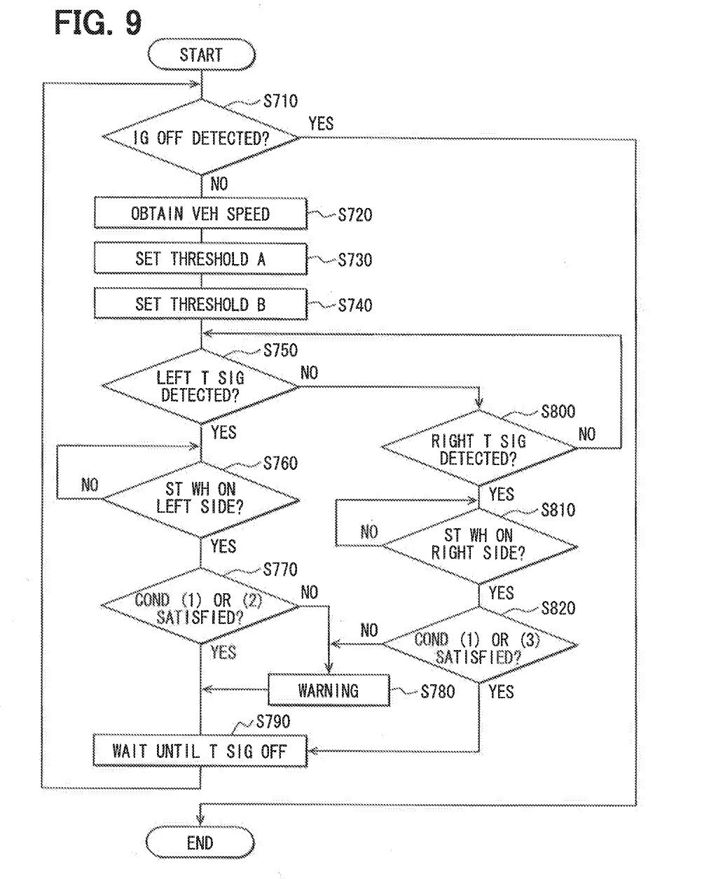

A process executed by the driving condition determination apparatus 1 (i.e., the ECU 3) will be explained with reference to FIGS. 2 and 9.

(1) Process for Detecting a Face Direction and a Visual Line Direction

The apparatus 1 repeats the process for detecting a face direction and a visual line direction in FIG. 2 at predetermined time intervals, similar to the first embodiment.

(2) Driving Condition Determination Process

The apparatus 1 repeats a driving condition, determination apparatus in FIG. 9 at predetermined time intervals independently from the process for detecting the face direction and the visual line direction.

In step S710, the apparatus 1 detects whether an ignition switch of the vehicle is in an off state. When the ignition switch is not in the off state, it goes to step S720. When the ignition switch is in the of state, the process ends.

In step S720, the vehicle speed detector 13 detects the vehicle speed of the vehicle, on which the apparatus 1 is mounted.

In step S730, the apparatus 1 sets the threshold value A according to the vehicle speed of the vehicle detected in step S720. The setting method of the threshold value A is similar to the third embodiment.

In step S740, the apparatus 1 sets the threshold value B according to the vehicle speed of the vehicle detected in step S720. The setting method of the threshold value B is similar to the fourth embodiment.

In step S750, the apparatus 1 determines whether the turn signal detector 9 detects the left turn signal. When the detector 9 detects the left turn signal, it goes to step S760. When the detector 9 does not detect the left turn signal, it goes to step S800.

In step S760, the apparatus 1 determines whether at east one of the following conditions (XL) and (YL) is satisfied.

(XL) The steering wheel angle is equal to or larger than the threshold value A on the left side.

(YL) The duration time of a state such that the steering wheel angle on the left side is continuously equal to or larger than 10 degrees (which is a standard value) is larger than the threshold value B.

When both of the above conditions (XL) and (YL) are not satisfied, the apparatus repeats step S760. When at least one of the above conditions (XL) and (YL) is satisfied, it goes to step S770.

In step S770, the apparatus 1 reads out all of the information about the face direction and the visual line direction of the driver (stored in step S30), which has been stored in the memory in the ECU 3 for last three seconds just before the apparatus 1 detects that at least one of the above conditions (XL) and (YL) is satisfied. Further, the apparatus 1 determines whether at least one of the following conditions (1) and (2) is satisfied in the read-out information about the face direction and the visual line direction.

(1) The face direction and/or the visual line direction turn to the rearview mirror.

(2) The face direction and/or the visual line direction turn to the left side mirror or a door mirror.

The definition of the direction toward the rearview mirror and the direction toward the left side mirror or the door mirror is the same as in the first embodiment.

When both of the above conditions (1) and (2) are not satisfied, it goes to step S780. When at least one of the above conditions (1) and (2) is satisfied, it goes to step S790.

In step S780, the apparatus 1 controls the speaker of the warning device 11 to output a warning sound or a voice message “attention, please,”

In step S790, the apparatus waits until the turn signal is off. After that, it goes to step S710.

When the determination in step S750 is “NO,” it goes to step S800. In step S800, the apparatus 1 determines whether the turn signal detector 9 detects the right turn signal. When the turn signal detector 9 detects the right turn signal, it goes to step S810. When the turn signal detector 9 does not detect the right turn signal, it goes to step S750.

In step S810, the apparatus 1 determines whether at least one of the following conditions (XR) and (YR) is satisfied.

(XR) The steering wheel angle is equal to or larger than the threshold value A on the right side.

(YR) The duration time of a state such that the steering wheel angle on the right side is continuously equal to or larger than 10 degrees (which is a standard value) is larger than the threshold value B.

When both of the above conditions (XR) and (YR) are not satisfied, the apparatus repeats step S810. When at least one of the above conditions (XR) and (YR) is satisfied, it goes to step S820.

In step S820, the apparatus 1 reads out all of the information about the face direction and the visual line direction of the driver (stored in step S30), which has been stored in the memory in the ECU 3 for last three seconds just before the apparatus 1 detects that at least one of the above conditions (XR) and (YR) is satisfied. Further, the apparatus 1 determines whether at least one of the following conditions (1) and (2) is satisfied in the read-out information about the face direction and the visual line direction.

(1) The face direction and/or the visual line direction turn to the rearview mirror.

(3) The face direction and/or the visual ine direction turn to the right side mirror or a door mirror.

Here, the definition of the direction toward the rearview mirror and the direction toward the right side mirror or the door mirror is the same as in the first embodiment.

When both of the above conditions (1) and (3) are not satisfied, it goes to step S780. When at least one of the above conditions (1) and (3) is satisfied, it goes to step S790.

3. Effects of Apparatus

The driving condition determination apparatus 1 has the similar effects according to the first embodiment.

Further, in the apparatus 1 according to the present embodiment, the threshold values A and B are set according to the vehicle speed. Specifically, when the vehicle speed increases, the threshold values A and B are reduced. Thus, the apparatus 1 appropriately controls to output the warning sound and/or the warning message. Specifically, when the speed increases, the steering wheel angle for changing the traffic lane or turning right or left is reduced, and the duration time for turning the steering wheel in order to change the traffic lane or to turn right or left is reduced. Thus, when the threshold values A and B are set such that the threshold values A and B are reduced as the speed increases, the apparatus 1 determines in high accuracy without depending on the vehicle speed whether the vehicle changes the traffic lane or turns right or left.

In the first to fifth embodiments, the apparatus 1 includes the warning device 11. Alternatively, the apparatus 1 may not include the warning device 11, In this case, the determination results in steps S140, S190, S230, S260, S360, S410, S560, S610, S770, S820 may transmit through a signal to an external device. The external device outputs a warning sound and/or a warning message according to the determination results in steps S140, S190, S230, S260, S360, S410, S560, S610, S770, S820. Alternatively, the external device may store the determination results in steps S140, S190, S230, S260, S360, S410, S560, S610, S770, S820.

In the first to fifth embodiments, the apparatus 1 detects both of the face direction and the visual line direction. Alternatively, the apparatus 1 may detect only one of the face direction and the visual line direction. Further, the apparatus 1 performs the determination in steps S140, S190, S230, S260, S360, S410, S560, S610, S770, S820 with using the one of the face direction and the visual line direction.

In the above embodiments, the apparatus 1 reads out all of the information in the memory for last three seconds in steps S140, S190, S230, S260, S360, S410, S560, S610, S770, S820. Alternatively, the apparatus 1 may set the time other than last three seconds.

In the above embodiments, the apparatus 1 sets the threshold value A as 20 degrees. Alternatively, the apparatus 1 may set the threshold A other than 20 degrees in steps S130, S180, S220, S250.

In steps S130, S180, S220, S250, S350, S40, S550, S600, S760, S810, when the apparatus 1 continues to determine the result of “NO” for predetermine time interval, the apparatus 1 may end the process in FIGS., 3, 4, 6, 8 and 9.

In the fourth embodiment, the threshold value B may be fixed to a predetermined value. In this case, the apparatus 1 may not perform steps S520, S530. Further, in the fifth embodiment, at least one of the threshold values A and B may be fixed. When the threshold value A is fixed to a predetermined value, the apparatus 1 may not perform step S730. When the threshold value B is fixed to a predetermined value, the apparatus 1 may not perform step S740.

In the third to fifth embodiments, the apparatus 1 may not detect the turn signal, which is similar to the second embodiment.

Alternatively, the first to fifth embodiments may be combined.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driving condition determination apparatus comprising:
an image obtaining device for obtaining an image including a face of a driver of a vehicle;
a direction detector for analyzing the image and for detecting at least one of a face direction and a visual line direction of the driver;
a steering wheel angle detector for detecting a steering wheel angle of a steering wheel of the vehicle and for determining whether the steering wheel angle exceeds a predetermined first threshold value; and
a determination device for determining whether the at least one of the face direction and the visual line direction, which has been detected within a predetermined time interval just before the steering wheel angle detector determines that the steering wheel angle exceeds the predetermined first threshold value, satisfies at least one of a first condition and a second condition in a case where the steering wheel angle exceeds the predetermined first threshold value,
wherein the first condition is such that the at least one of the face direction and the visual line direction turns to a rearview mirror of the vehicle, and
wherein the second condition is such that the at least one of the face direction and the visual line direction turns to a door mirror or a side mirror disposed on a side, to which the steering wheel is turned.

2. The driving condition determination apparatus according to claim 1, further comprising:
a vehicle speed detector for detecting a vehicle speed of the vehicle; and
a threshold setting device for setting the first threshold value based on the vehicle speed.

3. The driving condition determination apparatus according to claim 1, further comprising:
a turn signal detector for detecting a turn signal,
wherein the determination device determines whether the at least one of the face direction and the visual line direction satisfies the at least one of the first condition and the second condition when the turn signal detector detects the turn signal.

4. The driving condition determination apparatus according to claim 3,
wherein the determination device does not determine whether the at least one of the face direction and the visual line direction satisfies the at least one of the first condition and the second condition when the turn signal detector does not detect the turn signal.

5. The driving condition determination apparatus according to claim 1, further comprising:
a warning device for outputting warning information when the determination device determines that both of the first condition and the second condition are not satisfied.

6. A driving condition determination apparatus comprising:
an image obtaining device for obtaining an image including a face of a driver of a vehicle;
a direction detector for analyzing the image and for detecting at least one of a face direction and a visual line direction of the driver;
a duration time detector for detecting an steering wheel angle of a steering wheel of the vehicle and for determining whether a duration time, for which the steering wheel angle is continuously equal to or larger than a predetermined standard value, exceeds a predetermined second threshold value; and
a determination device for determining whether the at least one of the face direction and the visual line direction, which has been detected within a predetermined time interval just before the duration time detector determines that the duration time exceeds the predetermined second threshold value, satisfies at least one of a first condition and a second condition in a case where the duration time exceeds the predetermined second threshold value,
wherein the first condition is such that the at least one of the face direction and the visual line direction turns to a rearview mirror of the vehicle, and
wherein the second condition is such that the at least one of the face direction and the visual line direction turns to a door mirror or a side mirror disposed on a side, to which the steering wheel is turned.

7. The driving condition determination apparatus according to claim 6, further comprising:
a vehicle speed detector for detecting a vehicle speed of the vehicle; and
a threshold setting device for setting the second threshold value based on the vehicle speed.

8. The driving condition determination apparatus according to claim 6, further comprising:
a turn signal detector for detecting a turn signal,
wherein the determination device determines whether the at least one of the face direction and the visual line direction satisfies the at least one of the first condition and the second condition when the turn signal detector detects the turn signal.

9. The driving condition determination apparatus according to claim 8,
wherein the determination device does not determine whether the at least one of the face direction and the visual line direction satisfies the at least one of the first condition and the second condition when the turn signal detector does not detect the turn signal.

10. The driving condition determination apparatus according to claim 6, further comprising:
a warning device for outputting warning information when the determination device determines that both of the first condition and the second condition are not satisfied.

11. A driving condition determination apparatus comprising:
an image obtaining device for obtaining an image including a face of a driver of a vehicle;
a direction detector for analyzing the image and for detecting at least one of a face direction and a visual line direction of the driver;
a steering wheel angle detector for detecting an steering wheel angle of a steering wheel of the vehicle and for determining whether the steering wheel angle exceeds a predetermined first threshold value;
a duration time detector for determining whether a duration time, for which the steering wheel angle is continuously equal to or larger than a predetermined standard value, exceeds a predetermined second threshold value; and
a determination device for determining whether the at least one of the face direction and the visual line direction, which has been detected within a predetermined time interval just before the steering wheel angle detector determines that the steering wheel angle exceeds the predetermined first threshold value or the duration time detector determines that the duration time exceeds the predetermined second threshold value, satisfies at least one of a first condition and a second condition in a case where the steering wheel angle exceeds the predetermined first threshold value, or the duration time exceeds the predetermined second threshold value,
wherein the first condition is such that the at least one of the face direction and the visual line direction turns to a rearview mirror of the vehicle, and
wherein the second condition is such that the at least one of the face direction and the visual line direction turns to a door mirror or a side mirror disposed on a side, to which the steering wheel is turned.

12. The driving condition determination apparatus according to claim 11, further comprising:
a vehicle speed detector for detecting a vehicle speed of the vehicle; and
a threshold setting device for setting at least one of the first threshold value and the second threshold value based on the vehicle speed.

13. The driving condition determination apparatus according to claim 11, further comprising:
a turn signal detector for detecting a turn signal,
wherein the determination device determines whether the at least one of the face direction and the visual line direction satisfies the at least one of the first condition and the second condition when the turn signal detector detects the turn signal.

14. The driving condition determination apparatus according to claim 13,
wherein the determination device does not determine whether the at least one of the face direction and the visual line direction satisfies the at least one of the first condition and the second condition when the turn signal detector does not detect the turn signal.

15. The driving condition determination apparatus according to claim 11, further comprising:
a warning device for outputting warning information when the determination device determines that both of the first condition and the second condition are not satisfied.
